(19) United States
(12) Patent Application Publication
(10) Pub. No.: US 2003/0114947 A1
(43) Pub. Date: Jun. 19, 2003

(54) Storage medium recording 3D CAD editing program, 3D CAD editing method, 3D CAD editing device and 3D CAD editing program

(76) Inventor: Kazuo Tanaguchi, Kawasaki (JP)

Correspondence Address: STAAS & HALSEY LLP, 700 11TH STREET, NW, SUITE 500, WASHINGTON, DC, 20001, US

(21) Appl. No.: 10/189,199

(22) Filed: Jul. 5, 2002

(30) Foreign Application Priority Data
Dec. 13, 2001 (JP) 2001-379428

(51) Int. Cl. G06F 19/00

(52) U.S. Cl. 700/98; 703/1

(57) ABSTRACT

A storage medium on which a three-dimensional CAD editing program enabling a computer to generate each constituent component by defining a three-dimensional shape, to store the generated constituent components in a constituent component database, to edit each of the constituent components stored in the constituent component, database, to judge whether two of the generated constituent components interfere with each other, and to perform the set operation of the two constituent components according to the history information stored in the history table, a three-dimensional CAD editing method thereof, a three-dimensional CAD device thereof and a three-dimensional CAD editing program thereof are provided. Thus, features and a component can be independently and freely edited at high speed without depending on their editing histories. Furthermore, a plurality of features and a plurality of components can be simultaneously edited without depending on their editing histories.

### BACKGROUND OF THE INVENTION

1. Field of the Invention

The present invention relates to a high-speed editing technology in a three-dimensional CAD (computer-aided design) device.

2. Description of the Related Art

Conventionally, the editing of a three-dimensional CAD device is made by designing and locating a plurality of constituent components with a variety of shapes. The data structure of each constituent component is hierarchical in that the data is composed of a point, a line composed of points, a surface composed of lines, a feature composed of surfaces and a component composed of features.

FIG. 1A shows the editing process of a conventional three-dimensional CAD device.

In FIG. 1A, constituent components to be edited are four futures; feature a ((1) base), feature b ((2) extrusion), feature c ((3) extrusion hole) and feature d ((4) gain), and component A composed of these features.

The editing of these constituent components is made in order of the generation of feature a ((1) base), the generation of feature b ((2) extrusion), the generation of feature c ((3) extrusion hole) and the generation of feature d ((4) gain).

FIGS. 1B, 1C and 1D show the editing process of the conventional three-dimensional CAD device and the database structure of the constituent component database together.

In FIG. 1B, a constituent component to be edited is feature a ((1) base).

In the generation of feature a ((1) base), first, a coordinate system, which is the basis of editing, is defined, and a three-dimensional shape (geometrical shape), which is a basic shape, is generated based on numeric values and coordinates input from an input device, such as a keyboard or the like. Then, the sectional shape of the generated three-dimensional shape is calculated based on constraints defined according to an equation, and a solid shape (feature) is generated by an extrusion process.

In FIG. 1C, a constituent component to be edited is feature b (extrusion (2)).

In the generation of feature b ((2) extrusion), the reference position of feature b is defined as the relative coordinates of feature a, based on the coordinates and shape of a feature (parent) generated immediately before, that is, feature a. Then, as in the generation of feature a, a three dimensional shape (geometrical shape), which is a basic shape, is generated based on a numeric value and coordinates input from an input device, such as a keyboard or the like. Then, the sectional shape of the generated three-dimensional shape is calculated based on constraints, and a solid shape (feature) is generated by an extrusion process. Furthermore, feature b defined here is added to the immediately previous feature a. Specifically, a set operation (sum, difference and product) is executed between features a and b.

In FIG. 1D, a constituent component to be edited is feature c ((3) extrusion hole).

In the generation of feature c ((3) extrusion hole), the reference position of feature c ((3) extrusion hole) is defined as the relative coordinates of feature b, based on the coordinates and shape of the feature b, and a three-dimensional shape (geometrical shape), which is a basic shape, is generated based on a numeric value and coordinates input from an input device, such as a keyboard or the like. Then, the sectional shape of the generated three-dimensional shape is calculated based on constraints, and a solid shape (feature) is generated by an extrusion process. Furthermore, feature c defined here is added to the feature b.

Similarly, the definition of a reference position, the generation of a three-dimensional shape, the generation of a feature and the addition to a parent feature are applied to feature d.

In this case, if an extrusion hole is generated in a specific feature of the hole of a specific feature is moved, the entire data structure of the feature is modified.

FIG. 1E shows the structure of each constituent component edited by the conventional three-dimensional CAD device.

As described with reference to FIG. 1D, in FIG. 1E, each pair of (1) base and (2) extrusion, (2) extrusion and (3) extrusion hole, and (3) extrusion hole and (4) gain has a parental relation, and except for (1) base, which is the highest-order parent feature, the reference position of each feature is restricted by the coordinates of its parent feature.

However, in the editing of the conventional three-dimensional CAD device described above, if a feature is defined or the defined feature is modified (if an extrusion hole (feature) is generated in a specific feature, or the hole (feature) of a specific feature is moved), the entire data structure of the specific feature must be modified. Therefore, process speed becomes low, which is a problem.

A parental relation is added to a defined feature in order of definition. Therefore, if an arbitrary feature is modified, at least a feature lower in order than the feature (child feature, grandchild, etc.) is also modified, and as a result, an undesired modification is made, which is another problem.

FIG. 1F shows a case where a constituent component is modified (edited) by the conventional three-dimensional CAD device.

In FIG. 1F, the modification of (2) extrusion being a feature leads to the modification of the reference position of (3) extrusion hole, which is the child feature of (2) extrusion. In this case, the modification of (3) extrusion hole is not desired. However, the shape modification of the extrusion leads to the position modification of (3) extrusion hole that has the relative coordinates of the modified position.

### SUMMARY OF THE INVENTION

The present invention is made to solve the problems described above, and it is an object of the present invention to provide a storage medium on which is recorded a three-dimensional CAD editing program enabling a computer to freely and independently edit features and a component at high speed without depending on their editing histories and further to simultaneously edit a plurality of features and a plurality of components without depending on their histories, a three-dimensional CAD editing method thereof and a three-dimensional CAD editing device thereof.

The three-dimensional CAD device of the present invention comprises a constituent component generating unit, a constituent component database, a shape processing unit, a history table, an interference processing unit and an operation processing unit.

In the first aspect of the present invention, the constituent component generating unit generates each constituent component by defining a three-dimensional shape.

The constituent component database stores the constituent components generated by the constituent component generating unit.

The shape processing unit edits each constituent component stored in the constituent component database.

The history table stores the history information of an editing process generated by the shape processing unit.

The interference processing unit judges whether two constituent components generated by the constituent component generating unit, interfere with each other.

Then, the operation processing unit executes the set operation of the two constituent components, according to their history information stored in the history table if the interference processing unit judges that the two constituent components interfere with each other.

In the second aspect or the present invention, a constituent component generating unit generates each constituent component by defining a three-dimensional shape.

The constituent component database stores the constituent components generated by the constituent component generating unit.

The shape processing unit edits each constituent component stored in the constituent component database.

The history table stores the history information of an editing process generated by the shape processing unit.

Then, the operation processing unit executes the set operation of two constituent components, according to their history information stored in the history table if the generation of constituent components by the constituent component generating unit and the editing of the constituent components by the shape processing unit is not performed for a prescribed time.

### BRIEF DESCRIPTIONS OF THE DRAWINGS

FIG. 1A shows the editing process of the conventional three-dimensional CAD device.

FIG. 1B shows the editing process and the database structure of the constituent component together (No. 1).

FIG. 1C shows the editing process and the database structure of the constituent component together (No. 2).

FIG. 1D shows the editing process and the database structure of the constituent component together (No. 3).

FIG. 1E shows the structure of each constituent component edited by the conventional three-dimensional CAD device.

FIG. 1F shows a case where a constituent component is moved and edited by the conventional three-dimensional CAD device.

FIG. 2A shows the functional configuration of three-dimensional CAD device adopting the present invention.

FIG. 2B is a flowchart showing the feature generating process of a feature generating unit 61.

FIG. 3 is a flowchart showing the component generating process of a component generating unit 62.

FIG. 4 is a flowchart showing the three-dimensional shaping process of a shape processing unit 65.

FIG. 5 is a flowchart showing the interfered part process of an interference processing unit 66.

FIG. 6 is a flowchart showing the interference state judging process of the interference processing unit 66.

FIG. 7A shows the content of the judgment requirement A of the interference state judging process.

FIG. 7B shows the content of the judgment requirement B of the interference state judging process.

FIG. 8 is a flowchart showing the inverse displaying process of an inverse display processing unit 68.

FIG. 9 shows the inverse display.

FIG. 10 shows the independence of each feature.

FIG. 11 shows that a constituent component can be always calculated based on its history, as requested.

FIG. 12A shows the interference state of two features (No. 1).

FIG. 12B shows the interfered calculation state of two features (No. 2).

FIG. 12C shows the interfered state of two features (No. 3).

FIG. 13A shows an example data structure of feature data, component data and interfered part data (No. 1).

FIG. 13B shows an example data structure of feature data, component data and interfered part data (No. 2).

FIG. 13C shows an example data structure of feature data, component data and interfered part data (No. 3).

FIG. 14 shows the difference between a case where an inverse process is performed and a case where no inverse process is performed.

FIG. 15 shows the correspondence between features and feature data.

FIG. 16 shows the correspondence between interfered parts and interfered part data.

FIG. 17 shows an example of a user's operation (movement/transformation of a feature).

FIG. 18 is a flowchart showing the process of the example operation shown in FIG. 17.

FIG. 19 shows a component and features to be operated by a user in FIGS. 20 through 25.

FIG. 20 shows an example of a user's operation where there is no need for set operation (No. 1).

FIG. 21 shows an example of a user's operation where there is no need for set operation (No. 2).

FIG. 22 shows an example of a user's operation where set operation is needed (where the need of a partial set operation is automatically judged (No. 1).

FIG. 23 shows an example of a user's operation where set operation is needed (where the need of a partial set operation is automatically judged (No. 2).

FIG. 24 shows an example of a user's operation where set operation is needed (where the need of a partial set operation is automatically judged (No. 3).

FIG. 25 shows an example of a user's operation where set operation is needed (where the need of a partial set operation is automatically judged (No. 4).

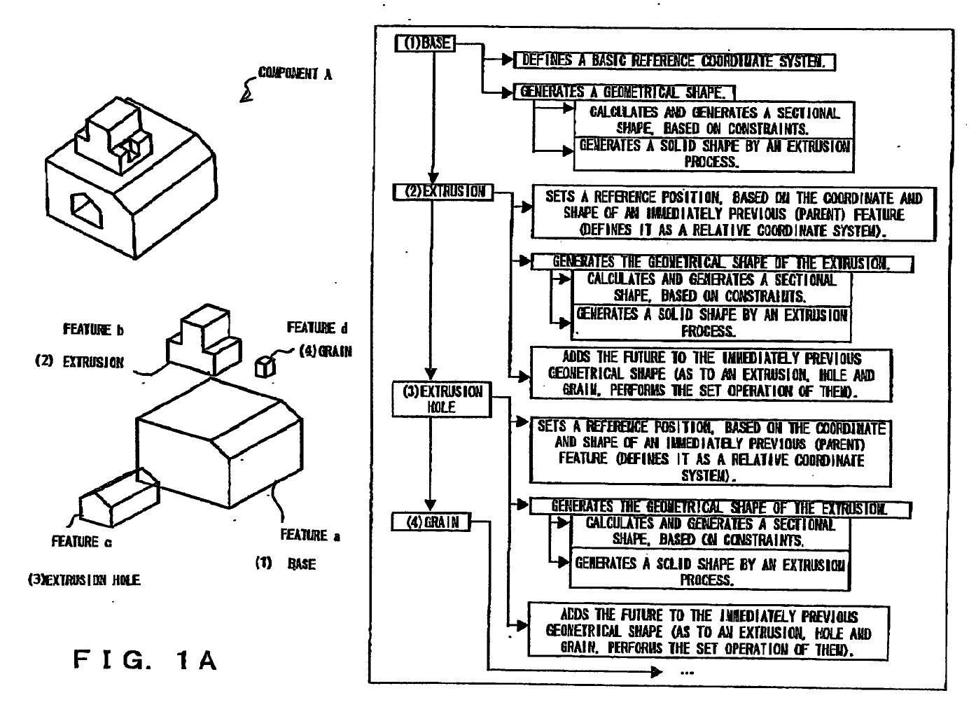

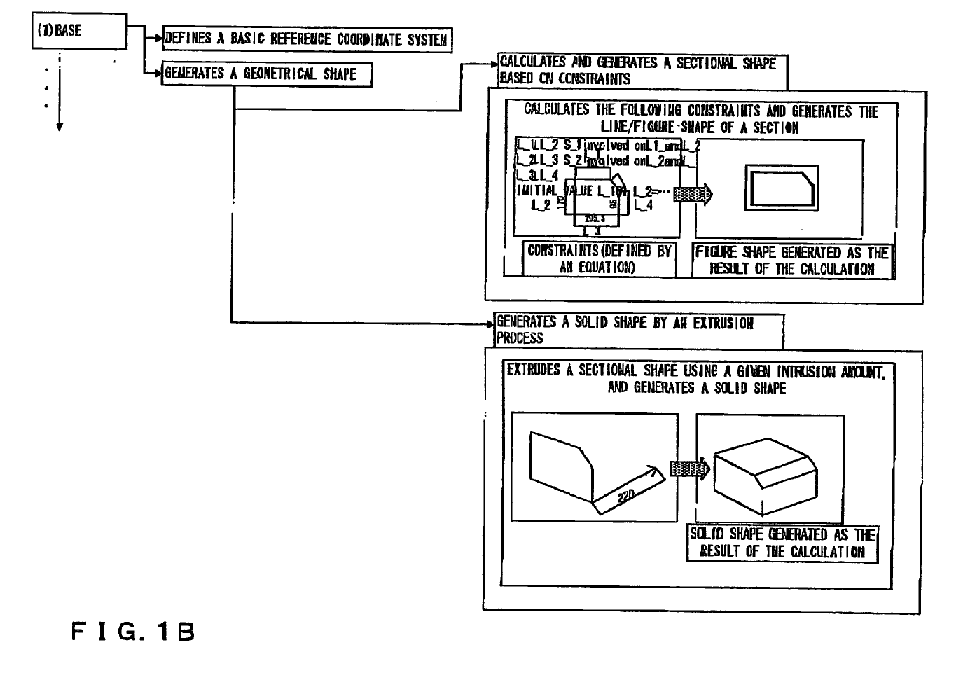

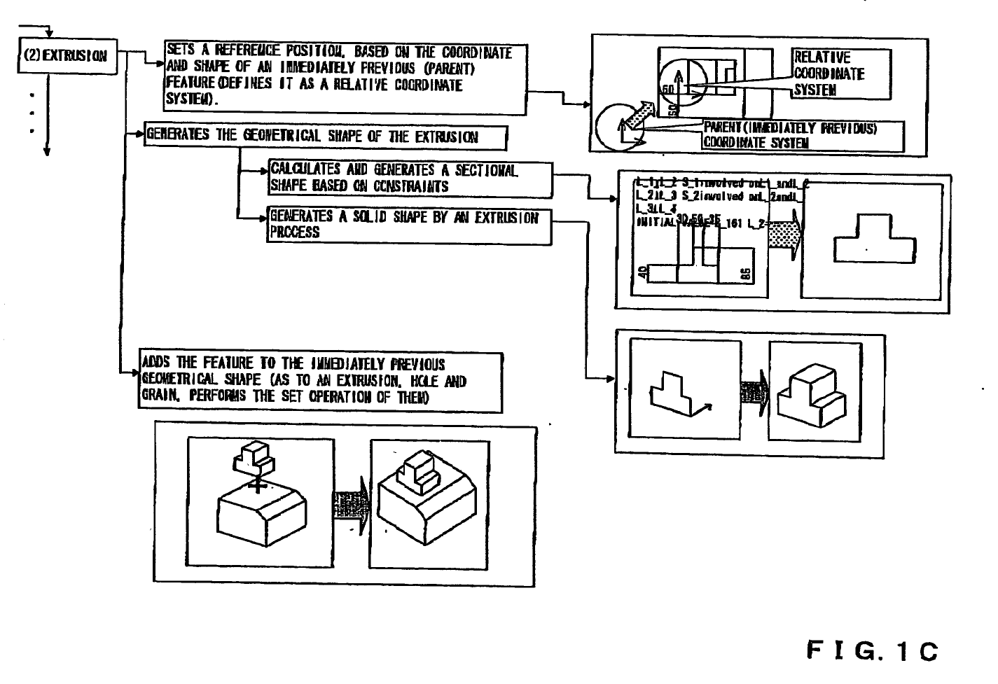

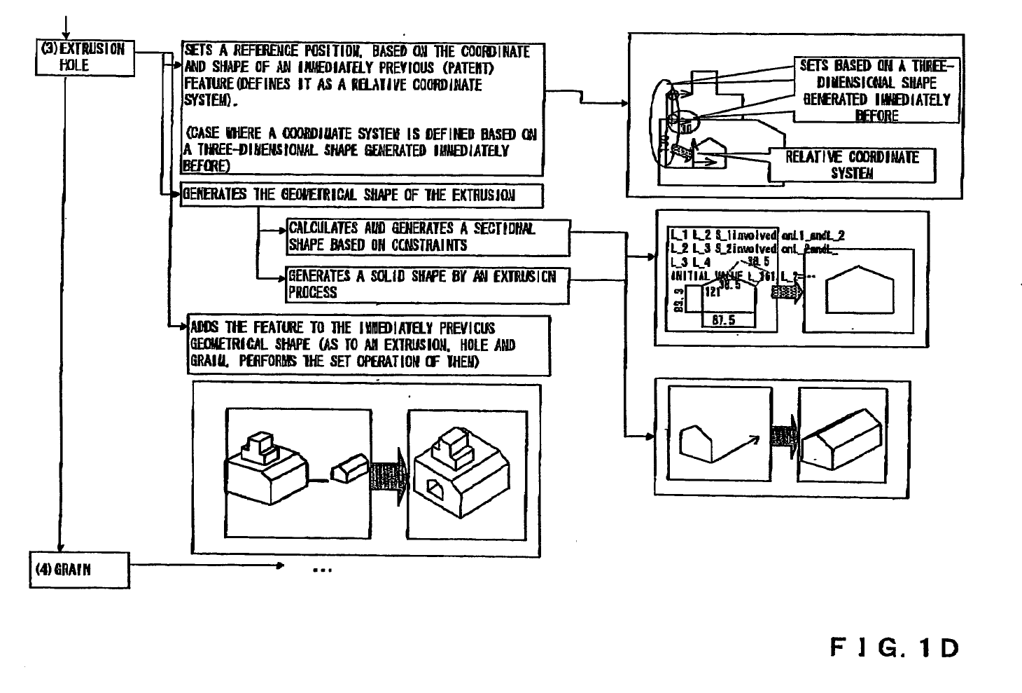

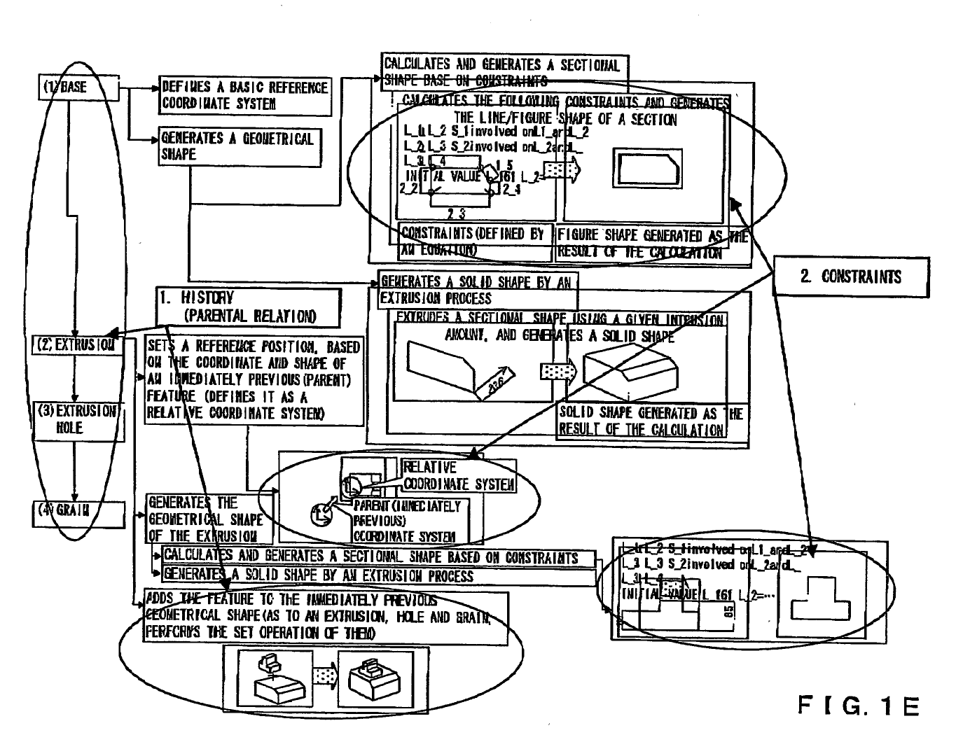

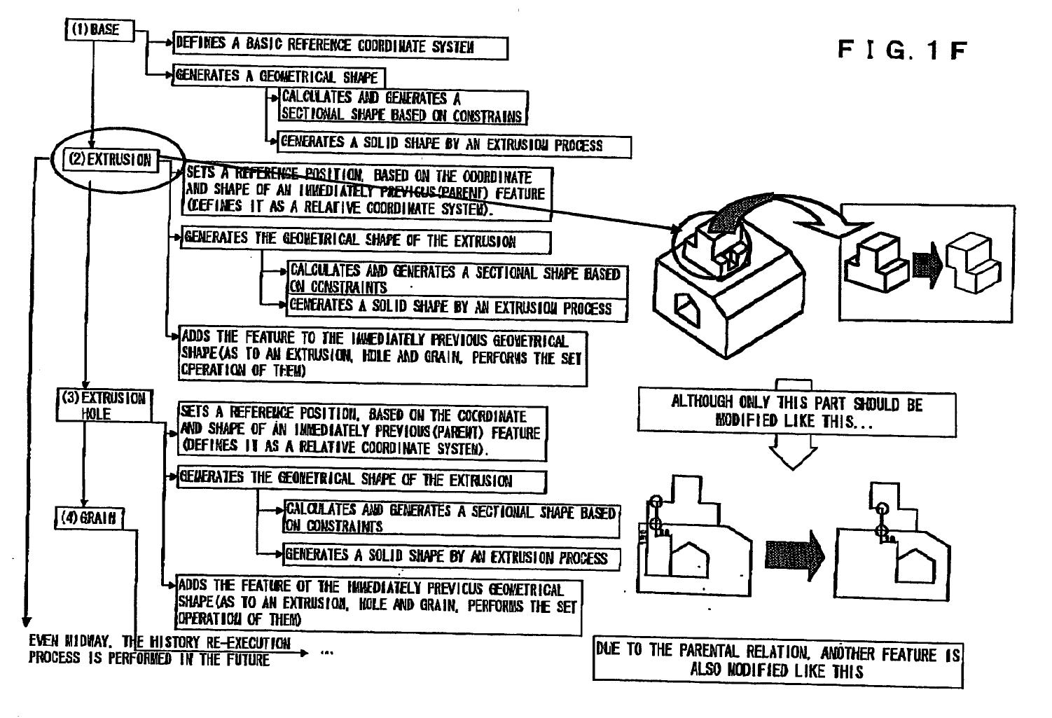

### DESCRIPTION OF THE PREFERRED EMBODIMENTS

The preferred embodiments of the present invention are described in detail with reference to the drawings.

The present invention adopts the following configurations in order to solve the problems described above.

Specifically, according to one aspect of the present invention, the storage medium on which is recorded the three dimensional CAD editing program of the present invention, three-dimensional CAD editing method thereof, three-dimensional CAD device thereof or three-dimensional CAD editing program, generate each constituents component by defining a three-dimensional shape; stores the generated constituent components in a constituents component database; edits each constituent component stored in a constituents component database; stores the history information of its editing process in a history table; judges whether two generated constituents components interfere with each other; and performs the set operation of the two constituents components, according to their history information stored in the history table.

Thus, features and a component can be freely and independently edited at high speed without depending on their editing histories, although conventionally, they cannot be edited due to the dependence on their editing histories, and furthermore a plurality of features and a plurality of components can be simultaneously edited without depending on their histories.

According to another aspect of the present invention, a storage medium on which is recorded the three-dimensional CAD editing program of the present invention, three-dimensional CAD editing method thereof, three-dimensional CAD device thereof or three-dimensional CAD editing program also generate each constituent component by defining a three-dimensional shape; stores the generated constituent components in a constituents component database; edits each constituent component stored in a constituents component database; stores the history information of its editing process in a history table; performs the set operation of two constituent components, according to their history information stored in the history table if the generation of constituent components by the constituent component generating unit and the editing of constituent components by the shape processing unit are not performed for a prescribed time.

It is preferable for the difference between the hole, grain, recess and another space of the constituent components, and the other constituent components to be explicitly displayed.

According to another aspect of the present invention, the three-dimensional CAD editing program can also be a computer-readable three-dimensional CAD editing program, including software program codes executing any of the three-dimensional CAD editing methods described above.

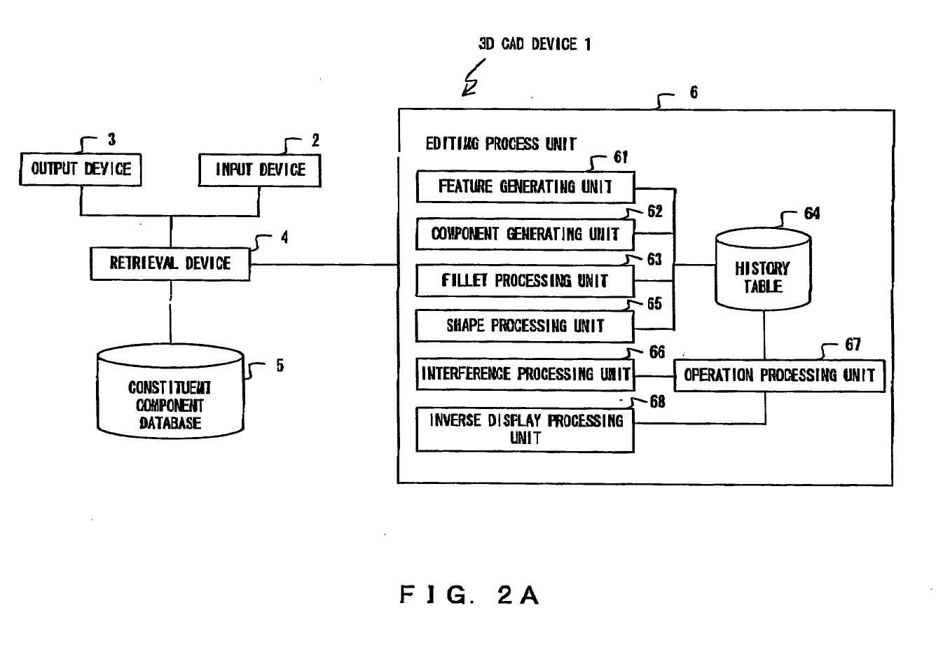

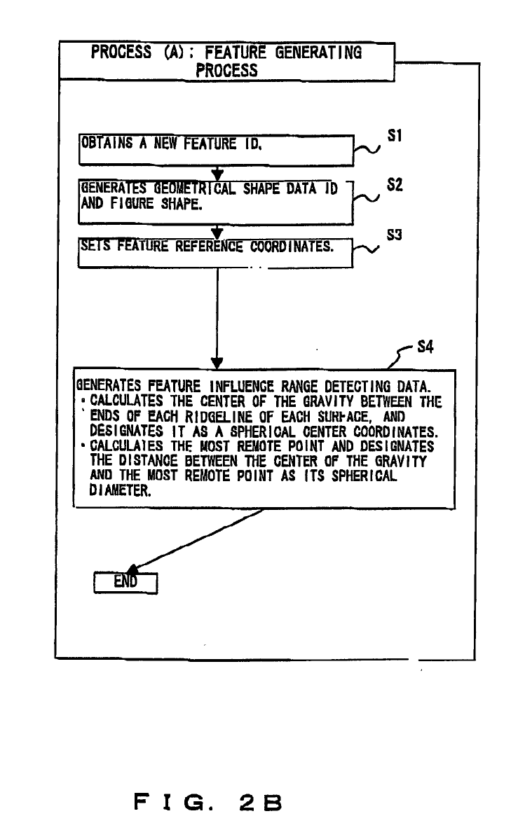

FIG. 2A shows the functional configuration of the three-dimensional CAD device adopting the present invention.

In FIG. 2A, a three-dimensional CAD device 1 comprises an input unit 2, such as a keyboard, a mouse or the like, an output unit 3, such as a CRT display, a liquid crystal display and the like, an retrieval unit 4, a constituent component database 5 storing features, a component and the like, and an editing process unit 6.

The editing process unit 6 further comprises a feature generating unit 61, a component generating unit 62, a fillet processing unit 63, a history table 64, a shape processing unit 65, an interference processing unit 66, an operation processing unit 67 and an inverse display processing unit 68.

The feature generation unit 61 generates each feature, which is a three-dimensional shape, using a point, a line composed of points and a surface composed of lines, based on a numeric value and coordinates input by the input unit 2, and stores the generated feature in the constituent component database 5.

The component generating unit 62 generates each component composed of features generated by the feature generating unit 61, and stores the generated component in the constituent component database 5.

The feature generating unit 61 and component generating unit 62 perform a function to generate each constituent component as a feature or a component by defining a three-dimensional shape.

The fillet processing unit 63 sets a fillet (roundness) in the angle of a component (rounds off the angle), and stores the shape data of the rounded feature or component in the constituent component database 5 again.

Thus, the three-dimensional shape and spatial position of each constituent component are explicitly expressed and they are overlapped and maintained (a constituent component is expressed) in a three-dimensional space. Each constituent component has attribute information about an extrusion, a hole, a fillet or the like.

The shape processing unit 65 edits the parallel movement, rotary movement, enlargement/reduction or the like of a feature/component, and stores the shape data of the edited feature/component in the constituent component database 5 again.

The history table 64 sequentially stores each process content of the generation of a feature by the feature generating unit, the generation of a component by the component generating unit 62, the setting of a fillet by the fillet processing unit 63 and the editing of a feature/component by the shape processing unit 65.

The interference processing unit 66 judges whether two of the generated features and components, the feature generated by the feature generating unit 61, the component generated by the component generating unit 62, with each other.

The operation processing unit 67 performs the set operation of two features/components, according to their history information stored in the history table 64 if the interference processing unit 66 judges that the two features/components interfere with each other. The operation processing unit 67 stores the shape data of the features/components after the set operation in the constituent component database again. Specifically, during the communication process (designing), the unnecessary history re-calculation, such as set operation or the like, is not conducted. Therefore, each constituent component can be locally edited without depending on its design history. Furthermore, a plurality of components/features can be simultaneously edited without depending on their design histories.

If the interference processing unit 66 does judges that the two features/components do not interfere with each other and if the generation and editing of two features/component are not performed for a prescribed time, the operation processing unit 67 can also perform the set operation of the two features/components, according to their history information stored in the history table 64.

The inverse display processing unit 68 explicitly displays the difference between the hole, grain, recess and another space of the constituent components, and the other constituent components.

Each of these units functions based on a program stored in the memory of the three-dimensional CAD device.

FIG. 2B is a flowchart showing the feature generating process of the feature generating unit 61.

In step S1, a new feature ID that is attached to a new feature to be generated is obtained.

In step S2, the ID of a three-dimensional shape (geometrical shape), which is a basic shape, is obtained and a three-dimensional shape is generated. Then, the sectional shape of the generated three-dimensional shape is calculated based on constraints, and a figure shape (feature) is generated by an extrusion process.

Then, in step S3, the reference coordinates of the generated feature are set.

Then, in step S4, data used to detect the possible influence range of the feature (feature influence range detecting data) is generated. Specifically, the center of the gravity between the ends of each of the respective ridgelines of each surface that constitutes the feature is calculated, and the data of a sphere with this center of the gravity and the distance between the center of the gravity and the most remote point as center coordinates and its diameter, respectively, is generated. In other word, the calculated sphere is the possible influence range of the feature.

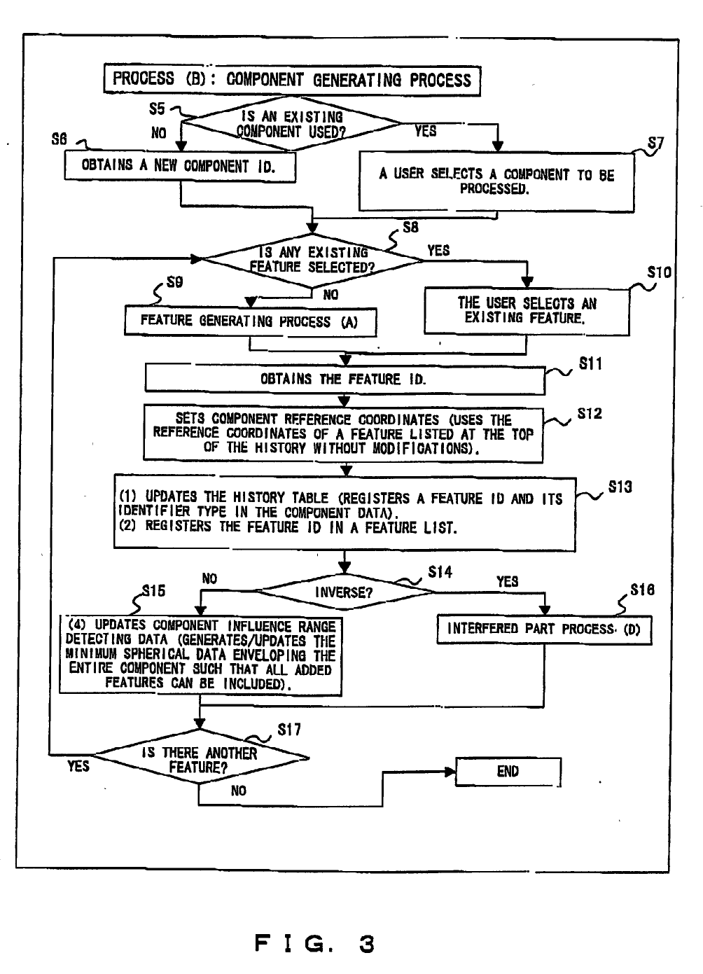

FIG. 3 is a flowchart showing the component generating process of the component generating unit 62.

In step S5, it is judged whether an existing component already generated should be used.

If in step S5 it is judged that the existing component should not be used (no in step S5), in step S6, the new ID of a new component to be generated is obtained.

If in step S5 it is judged that the existing component should be used (yes in step S5), in step S7 a user selects one from the existing components (obtains the ID of the component).

Then, in step S8, it is judged whether an existing feature already generated should be used.

If in step S8 it is judged that the existing feature should not be used (no in step S8), in step S9, a new feature is generated, as described in FIG. 2B.

If in step S8 it is judged that the existing feature should be used (yes in step S8), in step S10 the user selects the existing feature.

Then, in step S11, the ID of each of the generated or selected feature is obtained.

Then, in step S12, the reference coordinates of a component to be generated is set (the reference coordinates of the first feature (listed at the top of a history table) is used without modifications).

In step S13, the history table of the component is updated (the feature ID and identifier type of the component are registered), and the feature ID is registered in a feature list.

In step S14, it is judged whether the feature should be inversely displayed.

If in step S14 it is judged that the feature should not be inversely displayed (no in step S14), in step S15 data used to detect the possible influence range of the component is updated (the data of the minimum sphere enveloping the entire component such that each added feature can be included). Specifically, the center of the gravity between the ends of each of the ridgelines of each surface that constitutes the component is calculated, and the data of a sphere with this center of the gravity and the distance between the center of the gravity and the most remote point as center coordinates and its diameter, respectively, is generated. In other word, the calculated sphere is the possible influence range of the component.

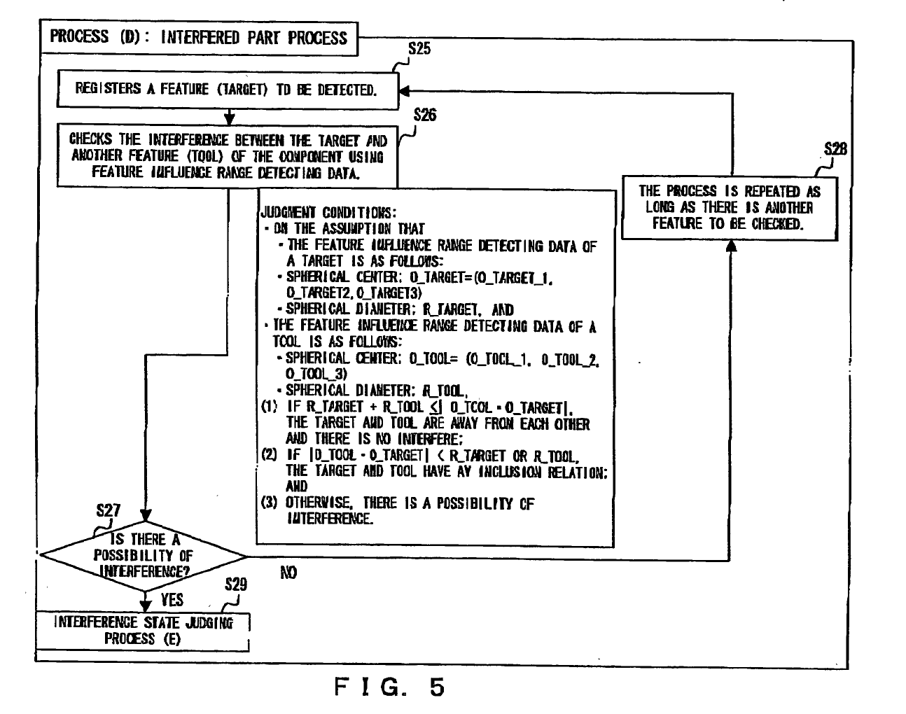

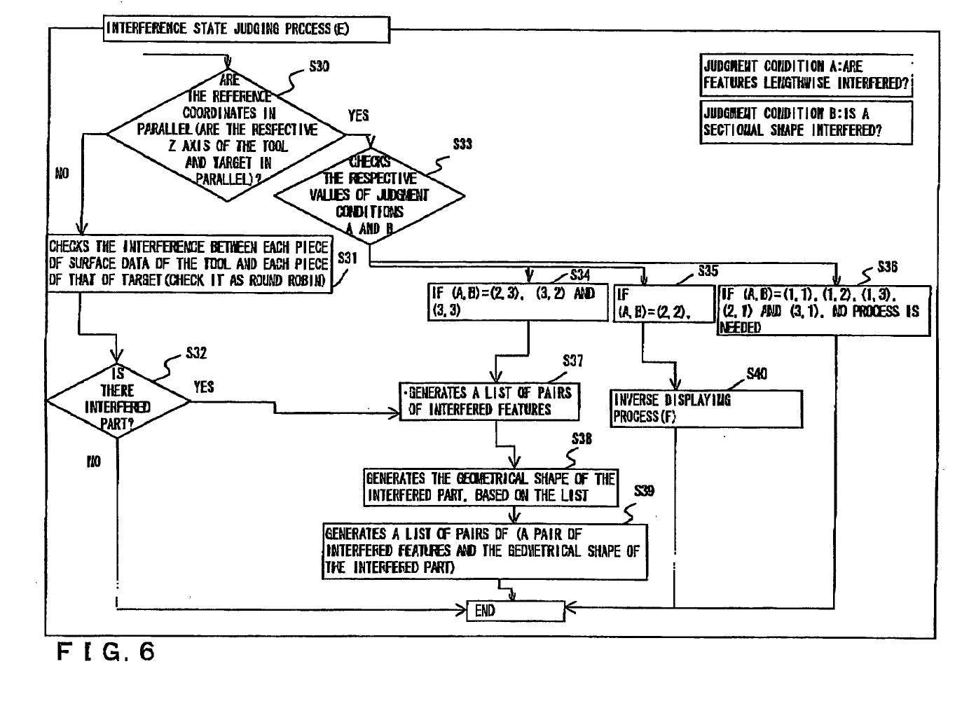

If in step S14 it is judged that the feature should be inversely displayed (yes in step S14), in step S16 an interfered part process, which is described later with reference to FIGS. 5 and 6, is performed.

Then, in step S17, it is judged whether there is another feature that is to constitute the component. If there is another feature that is to constitute the component (yes instep S17), steps S8 and after are repeated.

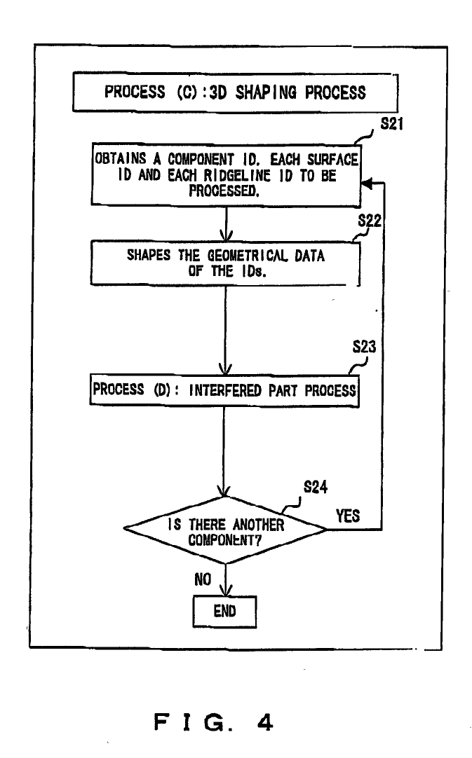

FIG. 4 is a flowchart showing the three-dimensional shaping process of the shape processing unit 65.

In step S21, the ID of a component to be processed, the ID of each feature, the ID of each surface constituting the component and each feature and the ID of each ridgeline are obtained.

Then, in step S22, a shaping process (general shape editing operation), such as the movement of a surface (enlargement/reduction operation), the movement of a feature (the movement of an extrusion, the movement of a hole, etc.), the movement of the component or the like is applied to the geometrical data of the component and the like (the geometrical data of a feature, the geometrical data of a surface and the geometrical data of a ridgeline).

Then, in step S23, the interfered part process, which is described later with reference to FIGS. 5 and 6, is performed, and in step S24 it is judged whether there is another component, which is a target of the shaping process. If there is such a component (yes in step S24), steps 21 and after are repeated.

FIG. 5 is a flowchart showing the three-dimensional shaping process of the interference processing unit 66.

Generally, if a diagram or model is generated using a data processing device, such as a computer or the like, the interference among generated components is checked. Specifically, although when a product is designed using a three-dimensional CAD device, the simulation test is applied to the designed product. In this simulation test, an interference check, which is one of mechanical analysis, is made.

If an interference check is made in the simulation test of a product or at its preceding stage, the interference check is applied to the entire product or is partially applied to only each specific constituent component which may suffer from interference. Specifically, if an interference check is applied to the entire product, a process amount increases and the check takes a lot of process time. Therefore, the interference check is often partially applied to only necessary constituent components.

If an interference check is instructed between features, in step S25 a feature (target), the interference of which is to be detected, is registered.

Then, in step S26, the interference between the target feature and another feature (tool) of the component is checked using feature influence range detecting data (see step S4 in FIG. 2B). Specifically, it is assumed that the spherical center and spherical diameter of the feature influence range detecting data of the target feature are O_Target-(O_Target_{—}1, O_Target_{—}2, O Target 3) and R_Target, respectively, and the spherical center and spherical diameter of the feature influence range detecting data of the tool feature are O_Tool=(O_Tool_{—}1, O_Tool_{—}2, O_Tool_{—}3) and R_Tool, respectively. In this case, (1) if R_Target+R_Tool≦|O_Tool·O_Target|, it is judged that they are away from each other and there is no interference. (2) If |O Tool·O_Target|<R_Target or R_Tool, it is judged that they have an inclusion relation. (3) Otherwise, it is judged there may be some interference.

Then, in step S27, it is judged whether there is a possibility of interference. Specifically, it is judged whether the result of the check in step S26 corresponds to case (3).

If in step S27 it is judged that there is a possibility or interference (yes in step S27), in step S29 an interfered state judging process, which is described later with reference to FIG. 6, is performed.

If it is judged that there is no interference (no in step S27), the flow returns to step S26, and steps S26 through S28 are repeated as long as there is another feature, the interference of which is to be checked.

FIG. 6 is a flowchart showing the interfered state judging process of the interference processing unit 66.

In step S30, it is judge whether the respective reference coordinates of a tool and a target are in parallel with each other (the z axis of the tool and the z axis of the target are in parallel with each other).

If it is judged that the respective reference coordinates of the tool and target are not in parallel with each other (no in step S30), in step S31 the interference between each piece of surface data of the tool feature and each piece of that of the target feature is checked in order as a round robin.

Specifically, the respective surfaces listed at the top are extracted from a list of surfaces constituting the tool feature and from a list of surfaces constituting the target feature. Then, the interference between these two surfaces is checked. After the check finishes, the second surface is extracted from the list of target features, and the interference between the second target surface and the top tool surface is checked. Similarly, a subsequent surface is extracted from the list of target features in order and the interference between the subsequent target and the top tool surface is checked. After the interference between the last target surface and the top tool surface is checked, the interference between the second tool surface and each target surface is checked. Such a process is repeated until the interference between the last tool surface and the last target surface is checked.

Then, in step S32, it is judged whether there is any interference between each surface constituting the tool feature and each surface constituting the target feature.

If in step S30 it is judged that the respective reference coordinates of a tool and a target are in parallel with each other (yes in step S30), in step S33 the respective values of judgment conditions A and D are checked.

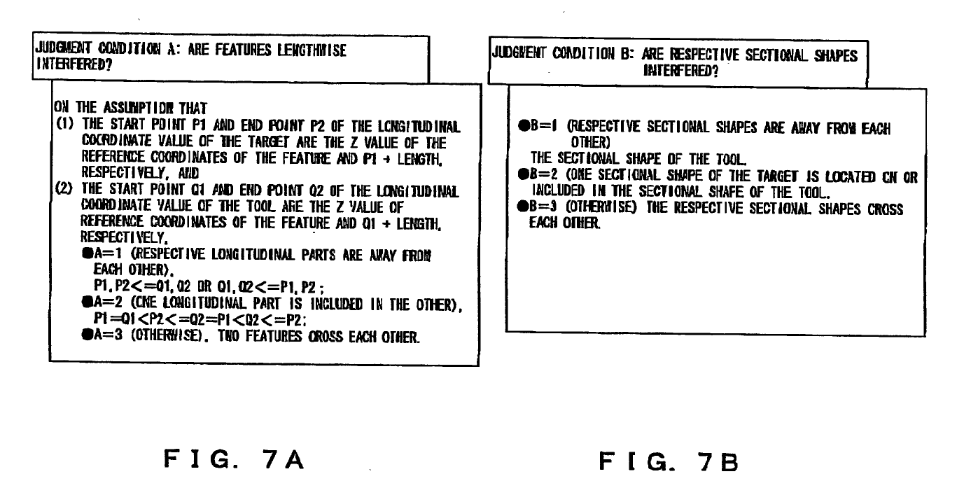

In this case, condition A is “Are target and tool features lengthwise interfered?” Specifically, it is assumed that the start point P1 and end point P2 of the longitudinal coordinate value of the target are the “Z value of feature references coordinates” and “P1 plus length”, respectively, and that the start point Q1 and end point Q2 of the longitudinal coordinate value of the tool are the “Z value of feature reference coordinates” and “Q1 plus length”, respectively. In this case, if P1, P2≦Q1, Q2 or Q1, Q2≦P1, P2, judgment A−1 (their longitudinal parts are away from each other) holds true. If P1=Q1<P2≦Q2 or Q1=P1<Q2≦P2, judgment A=2 (one of the target and tool includes the other) holds true. Otherwise, judgment A=3 (one of the target and tool crosses the other) holds true (see FIG. 7A).

Judgment condition B is “Are the respective sectional shapes interfered?” Specifically, if judgment b=1 (their sectional shapes are away from each other) holds true, the sectional shape of the target and the sectional shape of the tool are away from each other. If judgment b=2 (one of the target and tool crosses the other) holds true, the sectional shape of the target and the sectional shape of the tool are touched or one of the target and tool sectional shapes includes the other. If judgment b=3 (otherwise) holds true, one of the target and too sectional shapes crosses the other (see FIG. 7B).

If in step S33 the paired values of judgment conditions A and B are one of 2 and 3, 3 and 2, and 3 and 3 (Step S34), the flow proceeds to step S37. If in step S33 the paired values of judgment conditions A and B are 2 and 2 (step S35), the flow proceeds to step S40. If in step S33 the paired values of judgment conditions A and B are one of 1 and 1, 1 and 2, 1 and 3, 2 and 1, and 3 and 1, (step S36), the process terminates.

Then, if in step S32 it is judged that there is some interference between a surface constituting the tool feature and a surface constituting the target feature (yes in step S32) or if in step S33 the paired values judgment conditions A and B are one of 2 and 3, 3 and 2, and 3 and 3 (step S34), in step S37 a list of interfered pairs of target and tool features is generated.

Then, in step S38, the geometrical shape of a part judged to be interfered is generated based on the list generated in step S37, and in step S39, a list of pairs of “a pair of interfered target and tool features” and “the geometrical shape of an interfered part” is generated.

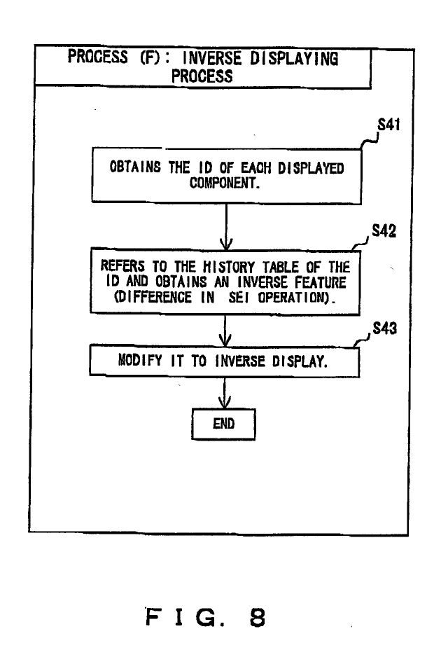

If the paired values of conditions A and B are 2 and 2 (step S35), in step S40 an inverse display process, which is described later with reference to FIG. 8 is performed.

FIG. 8 is a flowchart showing the inverse display process of the inverse display processing unit 68.

First, in step S41, the ID of each component to be displayed is obtained.

Then, in step S42, the history table of each of the components, the ID of which is obtained in step S41, is referenced and its inverse feature (difference in set operation) is obtained.

Then, in step S43, the display mode of the component is modified to inverse display.

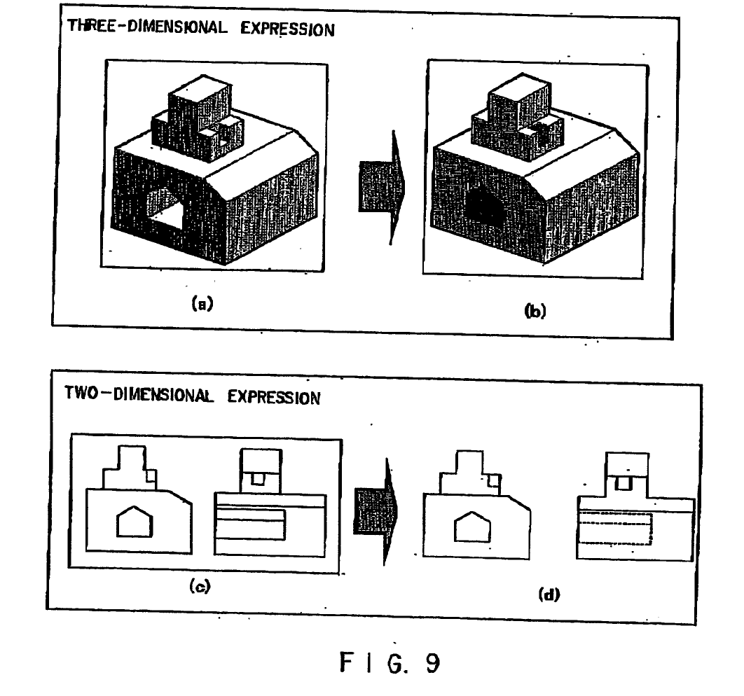

FIG. 9 shows inverse display.

Inverse display means to display an inverse feature (difference in set operation of a hole or the like, which is one form of feature constituting a component) in such a way that the difference between the inverse feature and another feature can be explicitly displayed. Thus, by devising a display state, necessary shape display can be provided during a communication process (designing using a three-dimensional CAD device).

If in a three-dimensional component shape as shown in FIG. 9(a), the shape of a hole or grain, which is expressed by a difference in set operation in a history type, and it is called an “inverse feature”, is displayed in the same way as another feature, such as an extrusion or the like, a user cannot recognize it. Therefore, in a three-dimensional space, an inverse feature is expressed, for example, using a specific color during CG display (see FIG. 9 (b)). During line/figure display, an inverse feature is, for example, displayed using a specific line color. In this case, although in two-dimension expression, as shown in FIG. 9 (c), an inverse feature can be recognized in some degree without performing any process, an inverse feature can also be displayed using hidden lines, as shown in FIG. 9 (d).

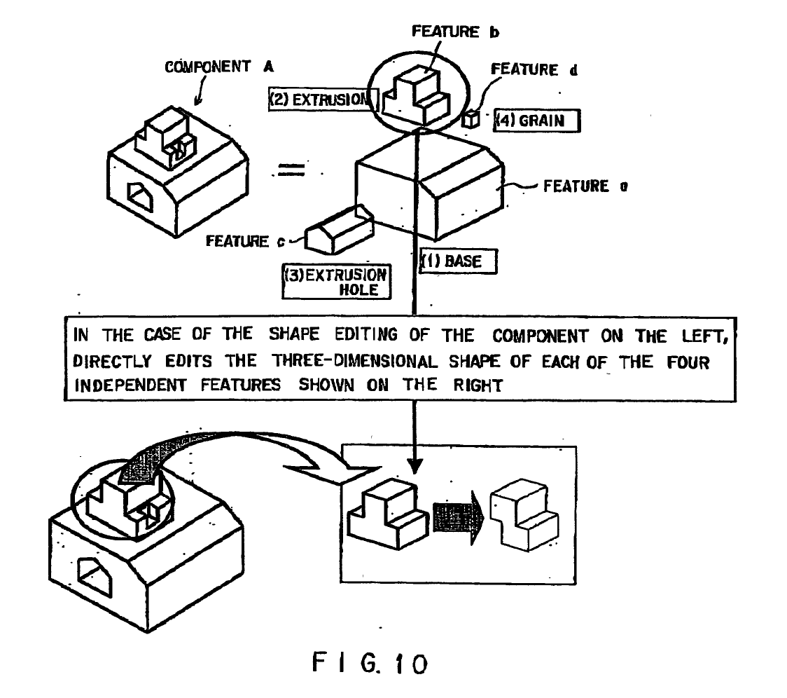

FIG. 10 shows the independence of each feature.

It is judged whether two generated features or components interfere with each other. If it is judged that these two constituent components interfere with each other, the set operation of the two constituent components is performed according to their history information stored in the history table. Therefore, during a communication process, history reference is seldom made. Specifically, only local calculation is conducted (interference can also be eliminated from interfered features/components, as requested, and the interference-eliminated features/components can also be expressed). Therefore, the three-dimensional shape of each independent feature (feature a, feature b, feature c or feature d) can be directly edited, and, as shown in FIG. 10, even if the shape of feature b is edited, the shape/position of another feature (feature a, feature c or feature d) is not affected.

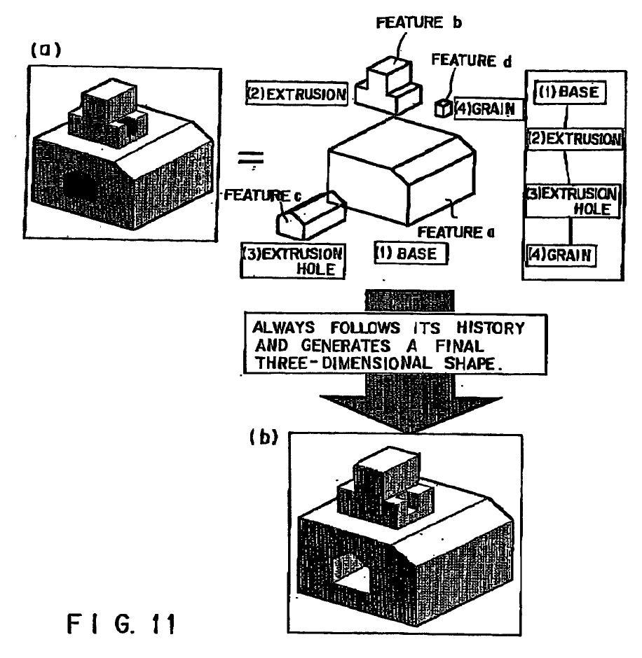

FIG. 11 shows that a feature can be always calculated and processed based on its history.

The component shown in FIG. 11 (a) is composed of feature a ((1) base), feature b ((2) extrusion), feature c ((3) extrusion hole) and feature d ((4) grain), and, as described with reference to FIG. 10, each of these constituent components is independent. In such a state, when a final three-dimensional shape is needed, for example, when a mass property calculation, such as weight calculation, the calculation of the center of the gravity or the like becomes necessary, when shape is confirmed in design review or the like, or if data is output to another system or application (output of STL or IGES), a final three-dimensional shape can be always generated by referring to a history stored in the history table (see FIG. 11 (b)).

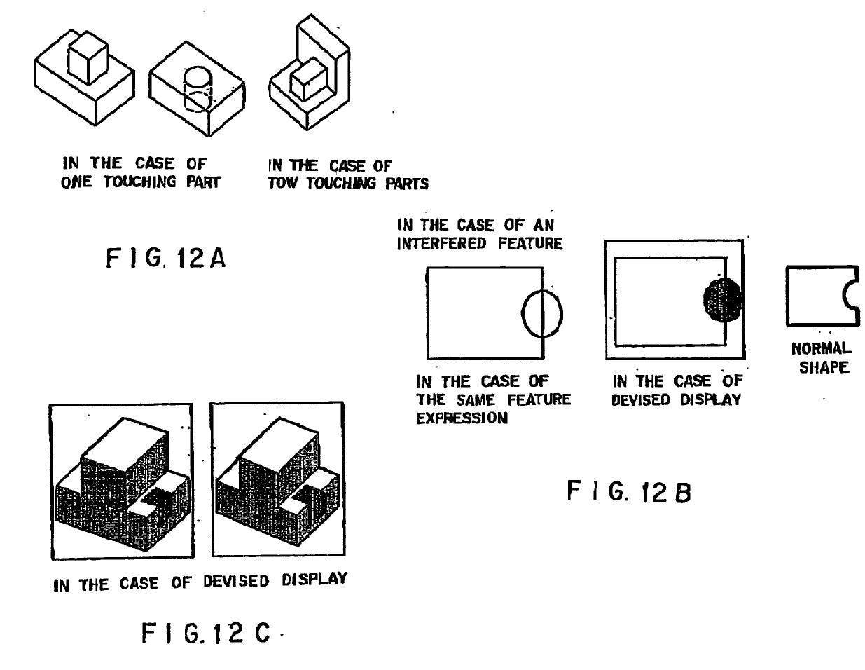

FIGS. 12A, 12B and 12C show the interfered state of two features.

The locational relation of two features can be grouped into the following four categories.

(1) In case surfaces are touched without crossing each other (FIG. 12A)

In this case, a surface of one feature and a surface of another feature are touched without crossing each other. Specifically, in this case, (a) a surface of one feature and a surface of another feature are touched and (b) the features are touched on only one surface. In other words, features are touched, but they do not cross each other. In this case, there is no need for set operation.

(2) In case one feature is completely enveloped in another feature

In this case, one feature is enveloped in another feature without crossing each other.

In this case, as in case (1), there is no need for set operation between the features.

(3) In case features are far away from each other

In this case too, as in cases (1) and (2), there is no need for set operation between the features.

However, if all features are far away from one another, such a component with a three-dimensional shape is unthinkable. Therefore, in such a case, there is an error.

(4) In other cases than cases (1) through (3) (surfaces cross each other) (FIG. 12B)

In this case, a surface of one feature and a surface of another feature cross each other.

In this case, there is some interference between them. Therefore, if an exact shape is needed, the interference must be eliminated from each of the interfered features.

However, such a shape can be recognized by using the “inverse display” described with reference to FIG. 9. Therefore, the editing process can be performed without set operation (see FIG. 12C).

Alternatively, correct shape data can be generated and displayed by applying set operation only to a feature with an influence range (in this case, although the calculation cost during designing increase, it is possible if a table with a set of an interfered constituent component, and an interference-eliminated shape data is added to the data structure).

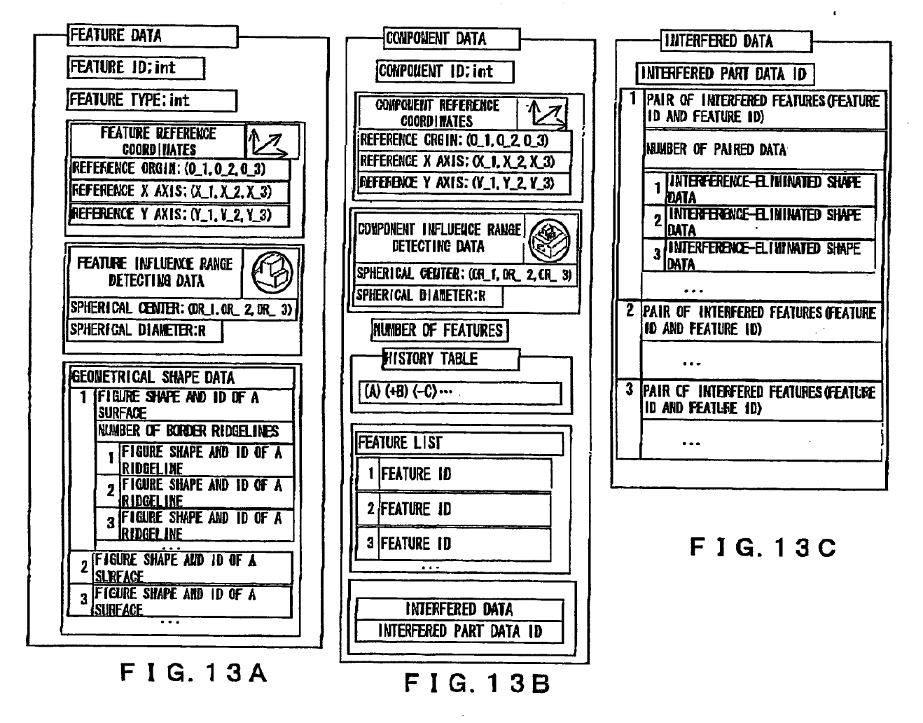

FIGS. 13A, 13B and 13C show example structures of feature data, component data and interfered part data, respectively.

FIGS. 13A, 13B and 13C show one structure of feature data, one structure of component data and one structure of interfered part data, respectively.

(1) An arbitrary feature ID, an arbitrary component ID and an arbitrary geometrical shape data ID of the same file (model) can be used.

(2) A geometrical shape has the coordinate value of the absolute coordinate system of the model.

(3) Feature/component influence range detecting data is, for example, the minimum spherical data, including the feature or component. Thus, a pre-treatment judging whether there is any interference can be performed at a low calculation cost.

(4) A history table stores a set of a feature ID and an identifier type.

(5) An identifier type (feature type) is basically expressed by set operation (extrusion=plus sign of set operation, hole= minus sign of set operation, shell-difference of set operation by which the original shape is transformed into an off-set shape, fillet=to be incorporated in the geometrical shaping process of each feature).

(6) Feature types (int) are follows. Feature typed=0; body of vertical projection (shape obtained by vertically extruding a sectional shape; in this case, the sectional shape is located on the XY plane of the reference coordinates and the extrusion direction is taken as the z axis); feature type=1: body of rotation; feature type- 2; a loft shape, etc., and extendable.

(7) Pain surface types (int) are as follows. Surface type-0; plain surface (defined by normal vector=(L_{—}1, L_{—}2, L_{—}3), reference point (d_{—}1, d_{—}2, d_{—}3); surface type=1: cylindrical surface, etc., and extendable.

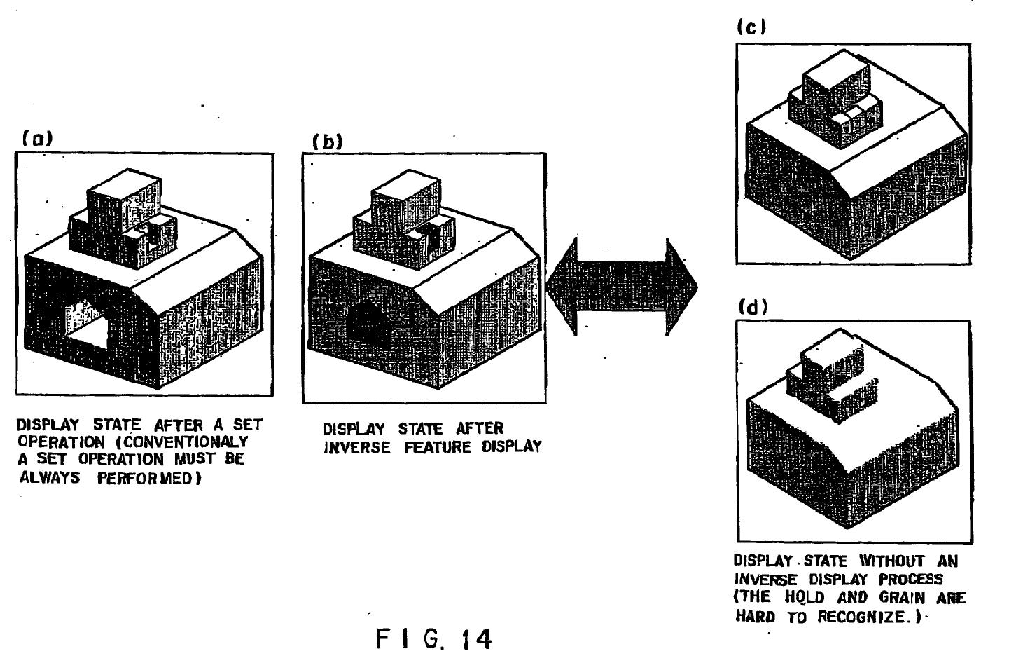

FIG. 14 shows the difference between a case where an inverse process is performed and a case where it is not performed.

FIG. 14 (a) shows a display state after set operation. Since conventionally a set operation is always performed, such display is always made even when there is not necessarily a need for such a display.

FIG. 14 (b) shows a display state where the display of an inverse feature is modified. In FIG. 14B, an inverse feature, such as a hole, a grain, etc., is displayed in a form different from other features. Although conventionally a set operation is always performed, a feature type can be obtained by devising display data thus, without set operation.

FIG. 14 (c) shows a display state without an inverse displaying process. Hole and grain shapes being inverse features are hard to recognize.

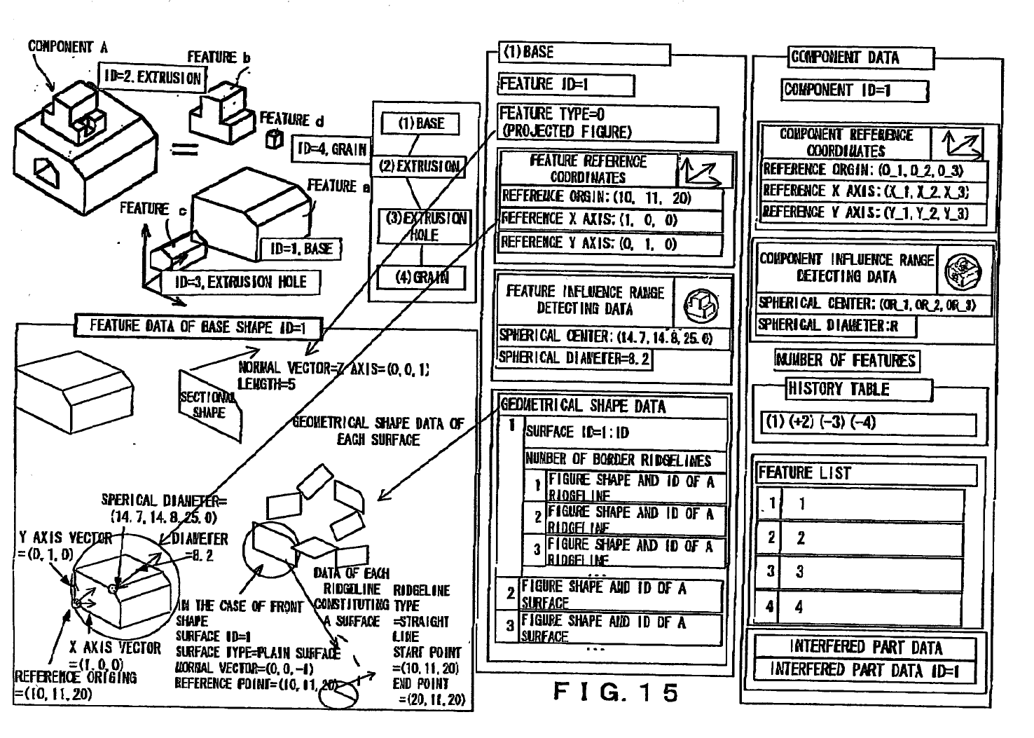

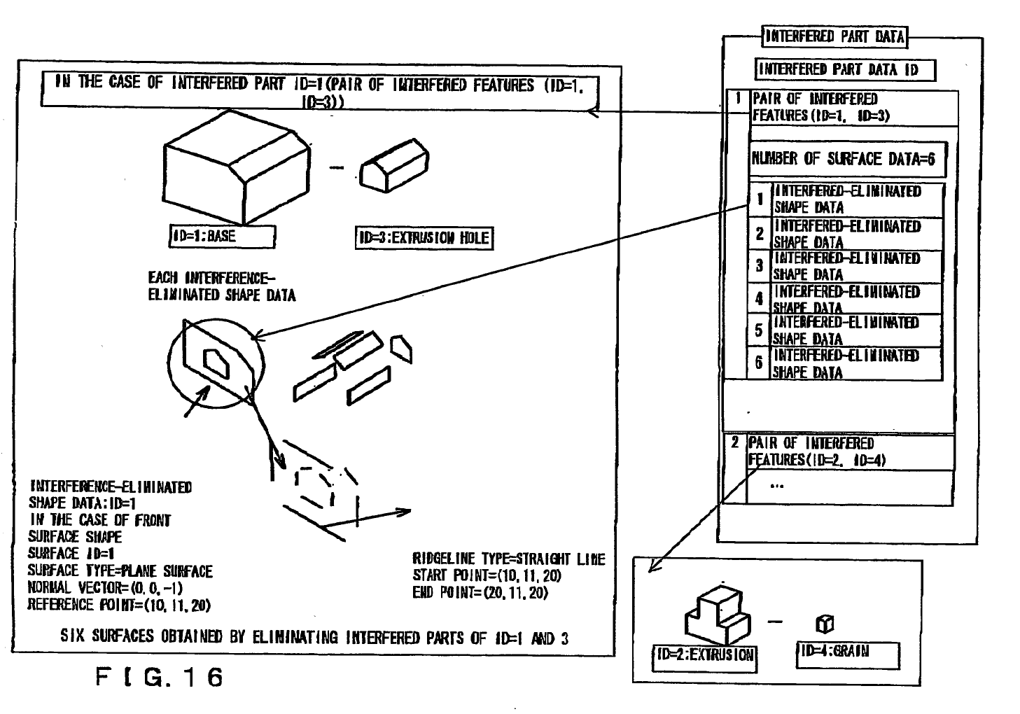

FIG. 15 shows the correspondence between features and their feature data

FIG. 15, component A is composed of feature a ((1) base), feature b ((2) extrusion), feature c ((3) extrusion hole) and feature d ((4) grain). In the case of feature ID=1, feature a takes feature type=0 (body of projection). Then, feature a has reference origin=(10, 11, 20), reference X axis=(1, 0, 0) and reference Y axis-(0, 1, 0) . Feature a also has a spherical center =(14, 7, 14, 8, 25, 0) and a spherical diameter-8.2 as feature influence range detecting data. Then, feature a has seven pieces of surface information of surface IDs 1 through 7 as geometrical shape data constituting feature a.

FIG. 16 shows the correspondence between interfered parts and their interfered part data.

In FIG. 16, between a base, which is the feature of feature ID=1, and an extrusion hole, which is the feature of feature ID=3, there is a relation that the extrusion hole is subtracted from the base. In this case, the feature of feature ID=1 is feature a ((1) base) described with reference to FIG. 15, and the feature of feature ID=3 is feature c ((3) extrusion hole described with reference to FIG. 15.

Similarly, between an extrusion, which is the feature of feature ID=2, and a grain, which is the feature of feature ID=4, there is a relation that the grain is subtracted from the extrusion.

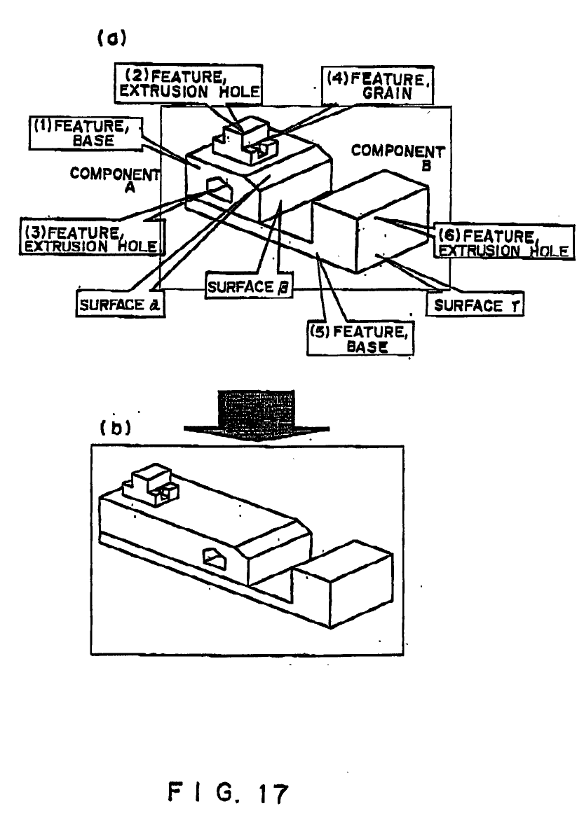

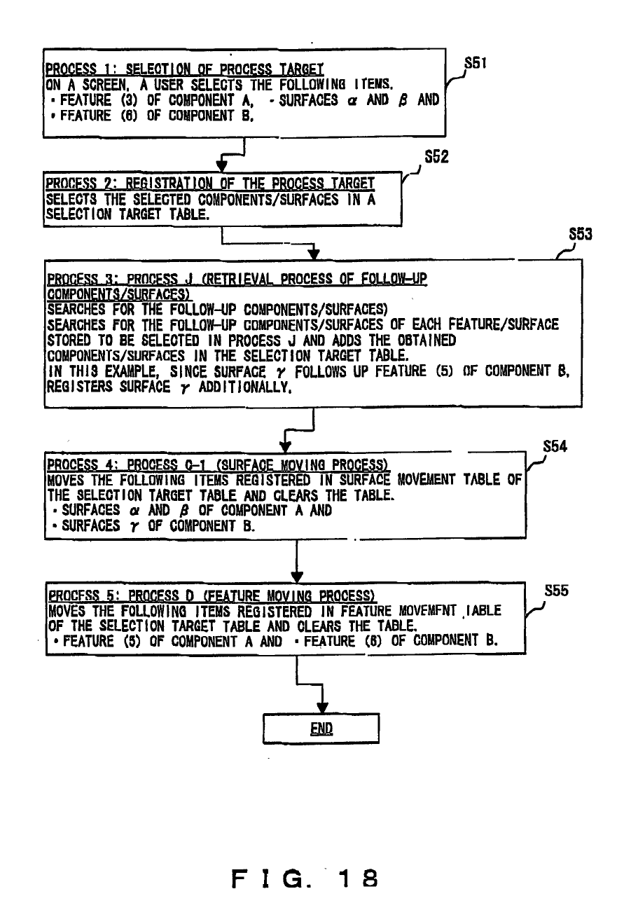

FIG. 17 shows a user's operation example (movement/transformation of a feature), and FIG. 18 is a flowchart showing the process of the operation example shown in FIG. 17.

Descriptions are given to FIGS. 17 and 18 below.

In step S51, a user the feature (3) extrusion hole and surfaces α and β of component A, and the feature (6) extrusion of component B are selected as process targets by a users selection/designation.

Then, in step S52, the features/surfaces selected/designated in step S51 are registered in a selection target table.

Then, in step S53, features, surfaces and the like following up the features/surfaces registered in the selection target table are searched for, and the obtained features/surfaces are added to the selection target table. In this example, since surface γ follows up the feature (5) base of component B, surface γ is added and registered.

In step S54, surfaces α and β of component A, and the surface γ of component B that are both registered in the surface movement table of the selection target table are moved, and the surface movement table is cleared.

Lastly, instep S55, the feature (3) extrusion hole of component A, and the feature (6) extrusion of component B that are both registered in the constituent component movement table of the selection target table are moved, and the constituent component movement table is cleared.

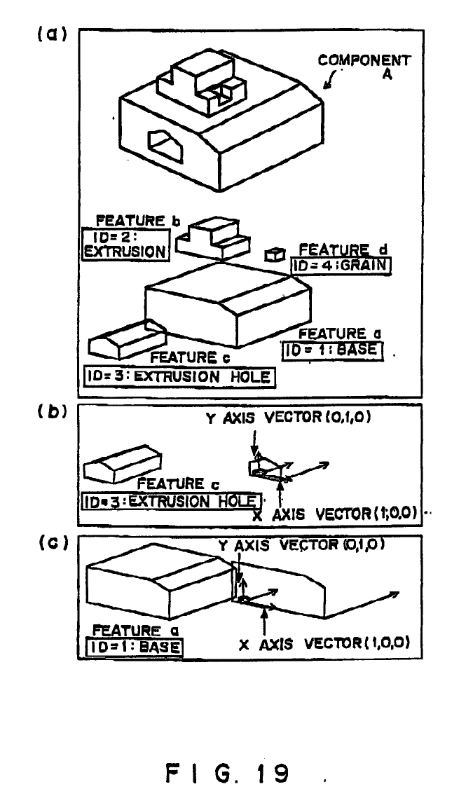

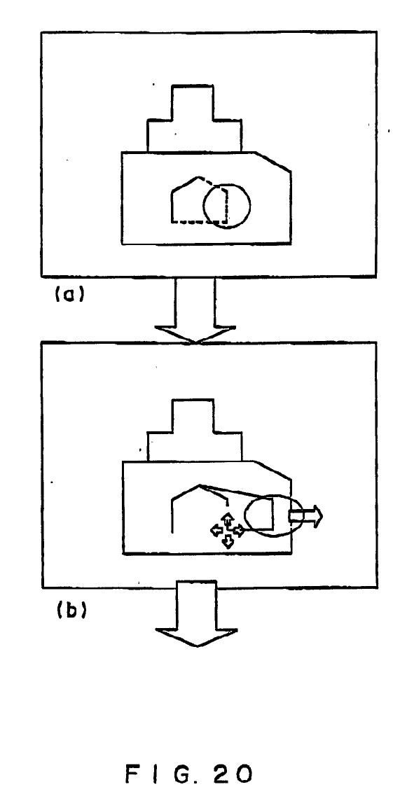

FIG. 19 shows the component/features, which are the targets of the user's example operation described with reference to FIGS. 20 through 25.

In FIG. 19, the constituent components to be operated by a user are feature a ((1) base), feature b ((2) extrusion), feature c ((3) extrusion hole), feature d ((4) grain) and component A composed of these features.

These constituent components have been generated by the processes described with reference to FIGS. 2B and 3. It is assumed that the respective sectional shapes of feature c (the extrusion hole of feature ID=3) and feature a (the base of feature ID=1) are in parallel with the XY plane, and the respective longitudinal directions of thereof are the same.

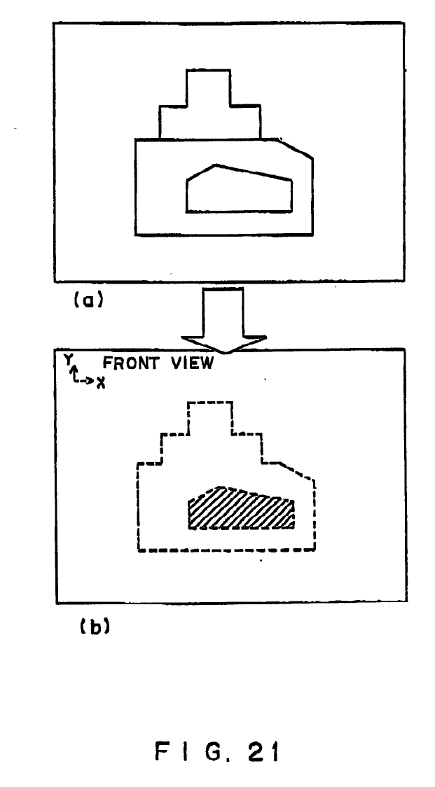

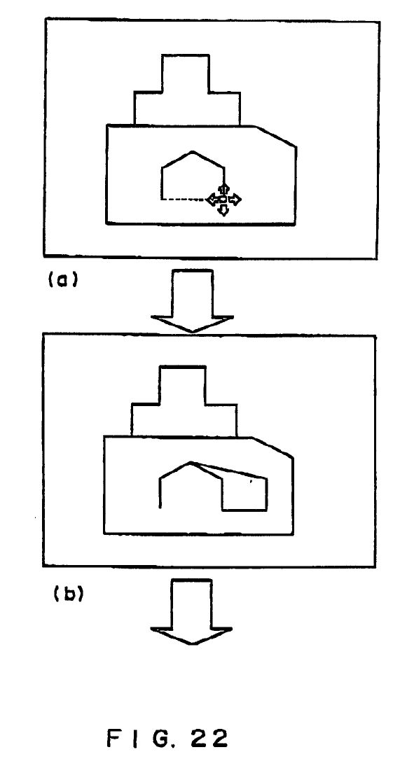

FIGS. 20 and 21 show a user's example operation performed when there is no need for set operation.

A case is described below where in component A shown in FIG. 19, the shape editing (shape enlargement/reduction) of feature c (the extrusion hole of feature ID=3) is performed.

First, a user selects a surface to the right of feature c (the extrusion hole of feature ID=3) (FIG. 20 (a)).

Then, the three-dimensional CAD device 1 obtains a component ID, surface ID and ridgeline IDs that are to be processed.

Then, the user moves the selected surface as shown in FIG. 20 (b) using a pointing device, such as a mouse or the like.

Then, the three-dimensional CAD device 1 performs the figure shaping process of a component, surface and ridgelines that are to be selected, by the shape processing unit 63.

Then, the shape processing unit 63 of the three-dimensional CAD device 1 moves the selected surfaces as shown in FIG. 21 (a), and terminates the shaping process.

Then, the three-dimensional CAD device 1 moves to the process of the interference processing unit 66.

First, when interference is checked using feature influence range detecting data in the interfered part process described with reference to FIG. 5, it is detected that there is a possibility of interference. Therefore, the process moves to the interfered state judging process described with reference to FIG. 6.

Then, since the respective sectional shapes of feature c (the extrusion hole of feature ID=3) and feature a (the base of feature ID=1) are in parallel with each other, and the respective longitudinal directions thereof are the same, it is judged that under judgment conditions A and B, A=2 and b-2 hold true, respectively, based on the shape state. In this case, since judgment conditions (A, B)=(2, 2), the inverse displaying process described with reference to FIG. 8 is performed (FIG. 21B).

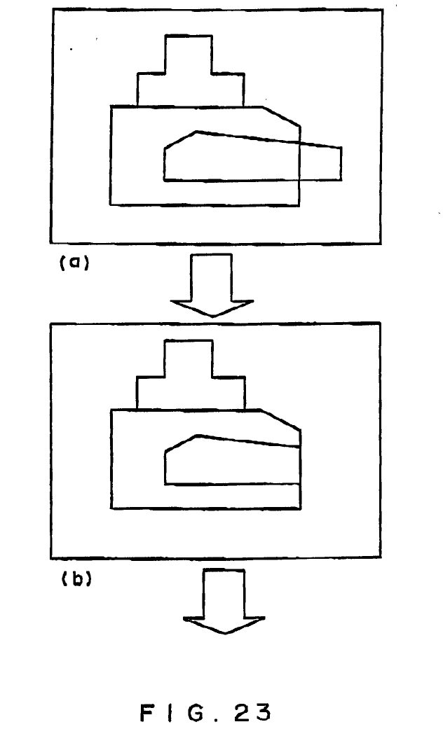

FIGS. 22 through 25 show a user's example operation performed when a set operation is needed (the need of a partial set operation is automatically judged).

As in the user's example operation described with reference to FIGS. 20 and 21, a case is described where in component A shown in FIG. 19, the shape editing (shape enlargement/reduction) of feature c (the extrusion hole of feature ID=3) is performed.

First, a user selects a surface to the right of feature c (the extrusion hole of feature ID=3) (FIG. 22 (a)).

Then, the three-dimensional CAD device 1 obtains the component ID, surface ID and ridgeline IDs that are to be processed.

Then, the user moves the selected surface as shown in FIG. 22 (b) using a pointing device, such as a mouse or the like.

Then, the three-dimensional CAD device 1 performs the figure shaping process of a component, surface and ridgeline that are to be selected, by the shape processing unit 63.

Then, the shape processing unit 63 of the three-dimensional CAD device 1 moves the selected surfaces a shown in FIG. 23 (a), and terminates the shaping process.

Then, the three-dimensional CAD device 1 moves to the process of the interference processing unit 66.

First, when interference is checked using feature influence range detecting data in the interfered part process described with reference to FIG. 5, it is detected that there is a possibility of interference. Therefore, the process moves to the interfered state judging process described with reference to FIG. 6.

Then, since the respective sectional shapes of feature c (the extrusion hole of feature ID-3) and feature a (the base of feature ID-1) are in parallel with each other, the respective longitudinal directions thereof are the same, and feature c (the extrusion hole of feature ID=3) interferes with the outside of feature a (the base of feature ID=1), it is judged that under judgment conditions A and B, A=2 and b-3 hold true, respectively. In this case, since judgment conditions (A, B)-(2, 3), interfered part data is generated.

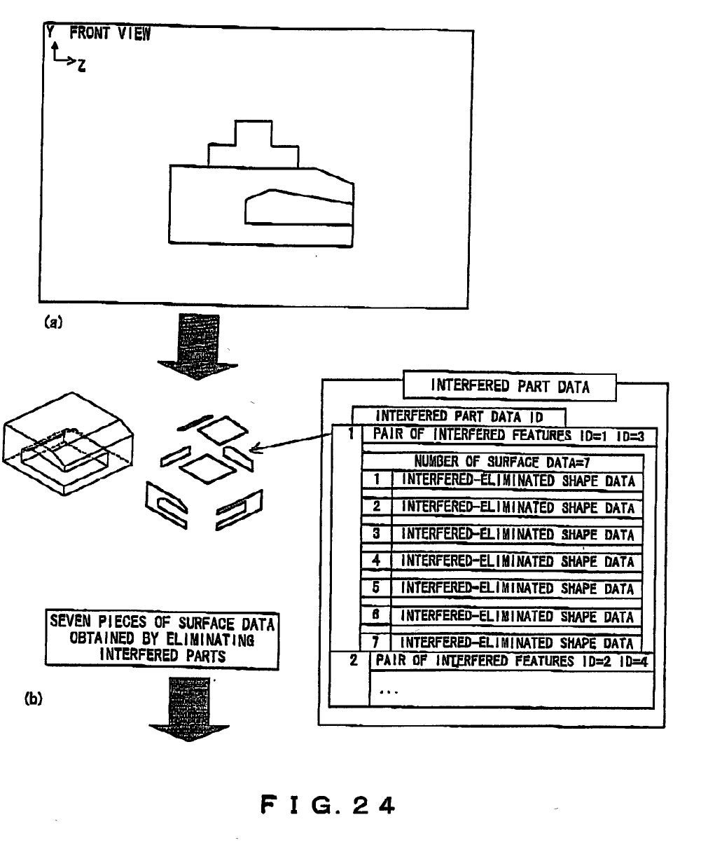

Specifically, the interference between features a and c is calculated, and interfered part data (see FIG. 24 (b)) is generated.

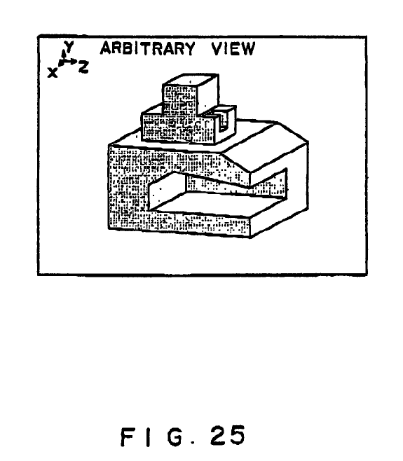

Then, lastly, the screen is obliquely operated, and the shape is confirmed (FIG. 25).

Although the preferred embodiments or the present invention have been described above with reference to the drawings, the three-dimensional CAD device adopting the present invention is not limited the preferred embodiments described above, and it can be single device, a system/incorporated device composed of a plurality of devices or a system in which the processes are performed through a network, such as a LAN, WAN or the like, as long as the functions are realized.

The present invention can also be realized by a system comprising a CPU, a memory, such as a ROM or a RAM, an input device, an output device, an external storage device, a medium driver device, a portable storage medium and a network connecting device, which are connected to one another by a bus. Specifically, if the three-dimensional CAD device is provided with a memory, such as a ROM or RAM, external storage device or portable storage medium on which are recorded software program codes realizing the preferred embodiment system described above, the present invention can also be realized by the computer of the three-dimensional CAD device reading and executing the program codes.

In this case, the program codes themselves read from a storage medium realize the new functions of the present invention, and a portable storage medium and the like on which the program codes are recorded constitute the present invention.

For the portable storage medium providing such program codes, a flexible disk, a hard disk, an optical disk, a magneto-optical disk, a CR-ROM, a CR-R, a DVD-ROM, a DVD-RAM, a magnetic tape, non-volatile memory card, a ROM card, a variety of storage media storing data through a network connecting device (that is, communication line), such as electronic mail, a personal communication, etc., or the like can be used.

The functions of the preferred embodiments described above can also be realized by an OS running in a computer performing a part of the process or the entire process, according to the instructions of the program codes instead of a computer reading the program codes in a memory and executing them.

Furthermore, the functions of the preferred embodiments described above can also be realized by writing the program codes read from a portable storage medium in a memory provided for a function extension board inserted in a computer or a function extension unit connected to a computer and by a CPU provided for a function extension board or function extension unit executing a part of the actual process or the entire process according to the instructions of the program codes.

In other words, the present invention is not limited to the preferred embodiments described above, and it can take a variety of configurations or forms as long as it does not deviate from the subject matter and scope of the present invention.

As described above, according to the present invention, features and a component can be independently and freely edited at high speed without depending on their editing histories. Furthermore, a plurality of features and a plurality of components can be simultaneously edited without depending on their histories.

What is claimed is:

1. A computer-readable storage medium on which is recorded codes for a three-dimensional CAD editing program executed on a three-dimensional CAD device, enabling a computer to execute a process, said process comprising:
generating each constituent component by defining a three-dimensional shape:
storing the generated constituent components in a constituent component database;
editing each of the constituent component stored in the constituent component database;
storing history information of its editing process in a history table;
judging whether two of the generated constituent components interfere with each other; and
performing a set operation of the two constituent components, according to their history information stored in the history table if it is judged that the two constituent components interfere with each other.

2. The computer-readable storage medium according to claim 1, wherein explicitly displaying a difference between a hole, grain, recess and another space of the constituent components and the other constituent components thereof.

3. A computer-readable storage medium on which is recorded codes for a three-dimensional CAD editing program executed on a three-dimensional CAD device, enabling a computer to execute a process, said process comprising:
generating each constituent component by defining a three-dimensional shape;
storing the generated constituent components in a constituent component database;
editing each of the constituent component stored in the constituent component database;
storing history information of its editing process in a history table; and
performing a set operation of the two constituent components, according to their history information stored in the history table if the generation of the constituent components and the editing of the constituent components are not performed for a prescribed time.

4. The computer-readable storage medium according to claim 3, wherein explicitly displaying a difference between a hole, grain, recess and another space of the constituent components and the other constituent components thereof.

5. A three-dimensional CAD editing method executed in a three-dimensional CAD device, comprising:
generating each constituent component by defining a three-dimensional shape;
storing the generated constituent components in a constituent component database;
editing each of the constituent components stored in the constituent component database;
storing history information of its editing process in a history table;
judging whether two of the generated constituent components interfere with each other; and
performing a set operation of the two constituent components, according to their history information stored in the history table if it is judged that the two constituent components interfere with each other.

6. A three-dimensional CAD editing method executed in a three-dimensional CAD device, comprising:
generating each constituent component by defining a three-dimensional shape;
storing the generated constituent components in a constituent component database;
editing each of the constituent components stored in the constituent component database;
storing history information of its editing process in a history table; and
performing a set operation of the two constituent components, according to their history information stored in the history table if the generation of the constituent components and the editing of the constituent components are not performed for a prescribed time.

7. A three-dimensional CAD device, comprising:
a constituent component generating unit each generating constituent component by defining a three-dimensional shape;
a constituent component database storing the constituent components generated by the constituent component generating unit;
a shape processing unit editing each of the constituent components stored in the constituent component database;
a history table storing history information of its editing process generated by the shape processing unit;
an interference processing unit judging whether two of the generated constituent components generated by the constituent component generating unit interfere with each other; and
an operation processing unit performing a set operation of the two constituent components, according to their history information stored in the history table if the interference processing unit judges that the two constituent components interfere with each other.

8. A three-dimensional CAD device, comprising:
a constituent component generating unit generating each constituent component by defining a three-dimensional shape;
a constituent component database storing the constituent components generated by the constituent component generating unit;
a shape processing unit editing each of the constituent components stored in the constituent component database;
a history table storing history information of its editing process in a history table; and
an operation processing unit performing a set operation of the two constituent components, according to their history information stored in the history table if the generation of the constituent components by the constituent component generating unit and the editing of the constituent components by the shape processing unit are not performed for a prescribed time.

9. A three-dimensional CAD editing program executed in a three-dimensional CAD device, enabling a computer to execute a process, said process, comprising:
generating each constituent component by defining a three-dimensional shape;
storing the generated constituent components in a constituent component database;
editing each of the constituent components stored in the constituent component database;
storing history information of its editing process in a history table;
judging whether two of the generated constituent components interfere with each other; and
performing a set operation of the two constituent components, according to their history information stored in the history table if it is judged that the two constituent components interfere with each other.

10. The three-dimensional CAD editing program according to claim 9, wherein explicitly displaying a difference between a hole, grain, recess and another space of the constituent components and the other constituent components thereof.

11. A three-dimensional CAD editing program executed in a three-dimensional CAD device, enabling a computer to execute a process, said process comprising:
generating each constituent component by defining a three-dimensional shape;
storing the generated constituent components in a constituent component database;
editing each of the constituent components stored in the constituent component database;
storing history information or its editing process in a history table; and
performing a set operation of the two constituent components, according to their history information stored in the history table if the generation of the constituent components and the editing of the constituent components are not performed for a prescribed time.

12. The three-dimensional CAD editing program according to claim 11, wherein explicitly displaying a difference between a hole, grain, recess and another space of the constituent components and the other constituent components thereof.

13. A three-dimensional CAD device, comprising:
constituent component generating means for generating each constituent component by defining a three-dimensional shape;
constituent component database means for storing the constituent components generated by the constituent component generating means;
shape processing means for editing each of the constituent components stored in the constituent component database means;
history table means for storing history information of its editing process generated by the shape processing means;
interference processing means for judging whether two of the generated constituent components generated by the constituent component generating means interfere with each other; and
operation processing means for performing a set operation of the constituent components, according to their history information stored in the history table means if the shape processing means judges that the two constituent components generated by the interference processing means interfere with each other.

14. A three-dimensional CAD device, comprising:
constituent component generating means for generating each constituent component by defining a three-dimensional shape;
constituent component database means for storing the constituent components generated by the constituent component generating means;
shape processing means for editing each of the constituent components stored in the constituent component database means;
history table means for storing history information of its editing process generated by the shape processing means; and
operation processing means for performing a set operation of the two constituent components, according to their history information stored in the history table means if the generation of the constituent components by the constituent component generating means and the editing of the constituent components by the shape processing means are not performed for a prescribed time.
